(19) United States
(12) Patent Application Publication
(10) Pub. No.: US 2025/0351820 A1
(43) Pub. Date: Nov. 20, 2025

(54) SUPRAMOLECULAR POROUS ORGANIC FRAMEWORKS FOR STORAGE AND DELIVERY OF VOLATILE GUESTS

(71) Applicant: KANSAS STATE UNIVERSITY RESEARCH FOUNDATION, Manhattan, KS (US)

(72) Inventors: Christer AAKEROY, Manhattan, KS (US); Kelly SHUNJE, Manhattan, KS (US)

(21) Appl. No.: 18/872,428

(22) PCT Filed: Jun. 6, 2023
(86) PCT No.: PCT/US2023/067952

§ 371 Date: Dec. 6, 2024

Related U.S. Application Data
(60) Provisional application No. 63/349,359, filed on Jun. 6, 2022.

(51) Int. Cl. A01N 25/12; A01N 25/18; A01N 61/00; A01P 17/00; A01P 19/00; A01P 21/00

(52) U.S. Cl. CPC A01N 25/12; A01N 25/18; A01N 61/00; A01P 17/00; A01P 19/00; A01P 21/00

(57) ABSTRACT

A porous framework in the form of a crystalline powder for gradual release of an active guest compound, such as volatile guests. The porous framework comprises a 3-dimensional host matrix of interconnected pores and open channels configured to house a guest compound, wherein said host matrix comprises a hydrogen-bonded organic framework (HOF) defining the pores and channels in which the guest is housed. Methods for delivering active guest compounds over time using the HOFs.

### CROSS-REFERENCE TO RELATED APPLICATIONS

The present application claims the priority benefit of U.S. Provisional Patent Application Ser. No. 63/349,359, filed Jun. 6, 2022, entitled SUPRAMOLECULAR POROUS ORGANIC FRAMEWORKS FOR STORAGE AND DELIVERY OF VOLATILE GUESTS, incorporated by reference in its entirety herein.

### BACKGROUND

### Field of the Invention

The present disclosure describes a molecular compound, which assembles via intermolecular forces into a porous and thermally stable crystalline solid (host), able to store and deliver a range of volatile substances (guests). The resulting materials are capable of providing new and versatile avenues for the controlled release of numerous high-value volatile guests.

### Description of Related Art

Volatile substances are utilized in a variety of areas such as food, detergents, personal care products, cosmetics, perfumes, agrochemicals, and pharmaceutical applications. High volatility inherently leads to a relatively short-lived effect and, consequently, there is need to develop molecular storage and delivery systems that can release high-value volatile compounds in a gradual or controlled manner, thereby extending the shelf-life and effectiveness of these compounds or materials in which they are contained.

Currently, the gradual or controlled release of volatile compounds is typically achieved using polymers or nano/microcapsules. To date, microencapsulation is the leading technology utilized for scent physical encapsulation and storage of volatile fragrances. Such physical encapsulation is stabilized by weak interactions like electrostatic attraction and in some cases hydrophobic-hydrophobic interactions. Another avenue for attaching the fragrance to the host is the profragrance approach. This involves the use of covalent binding where a precursor to the volatile compound is bound to the host via a labile covalent bond which can be broken upon exposure to external stimuli such as moisture, pH, or temperature. The encapsulation of volatiles within polymeric hosts still suffers from difficulty with control of morphology and pore size, and the host is often environmentally harmful.

An alternative to micro encapsulation can be provided by the use of porous materials such as zeolites, metal-organic frameworks (MOFs), and covalent organic frameworks (COFs). In some cases, they can, due to the large surface area and large pore size, overcome some of the limitations of polymeric capsules.

### SUMMARY

A relatively underexplored class of porous organic materials is represented by hydrogen-bonded organic frameworks (HOFs). Thus, in one aspect, the disclosure concerns a porous framework in the form of a crystalline powder for gradual release of an active guest compound. The crystalline powder comprises an effective amount of a 3-dimensional host matrix of interconnected pores and open channels configured to house the guest, wherein the host matrix comprises a hydrogen-bonded organic framework defining the pores and channels. Preferably at least one guest compound is a volatile compound, which is housed substantially within the host matrix.

Unlike MOFs and COFs, which are constructed via coordination and covalent bonds respectively, HOFs have weak hydrogen-bond connections between discrete building blocks which make them more versatile because of the reversible nature of the hydrogen bond. As such, this class of porous materials has some promising advantages including high crystallinity, high thermal stability, and, frequently, a biodegradable nature. In addition, the individual building blocks can be assembled according to reliable design principles of crystal engineering. Unlike MOFs, a metal component is unnecessary, which makes HOFs lightweight and more environmentally friendly. The reversible structural transformations of HOFs allow for potential use in applications like controlled release of adsorbed materials in response to a stimulus.

In another aspect described herein, the disclosure concerns methods of delivering an active guest compound over time or in a controlled manner. The method comprises providing a porous framework according to any one of the embodiments described herein (comprising a host matrix which houses a guest compound). Advantageously, the active guest compound is gradually released from the porous framework for a duration of time that is greater than the duration of release for a control active compound (i.e., the pure or naked active compound that is not contained in such a porous framework or otherwise encapsulated).

The use of a hydrogen-bonded porous organic framework offers a modular, lightweight, thermally stable, and biodegradable alternative to existing porous solids. The chemistry of the host can be modified in such a way that pore size and guest release rate can, in principle, be modified and tailored to a specific application. Controlled release of numerous high-value volatile guests is possible. The HOFs provide eco-friendly and controlled delivery of pesticides, herbicides, and fungicides. The materials can be integrated into devices for long-term and sustainable delivery and distribution of fragrances and odor-masking agents. The HOFs can be used for storage and delivery of volatile semiochemicals, as well as for the gradual release of molecules for food, detergents, personal care products, cosmetics, perfumes, agrochemicals, and pharmaceutical applications, such as fertilizers, pheromones, and household coatings, and the like. The HOFs can be used for storage and delivery of fragrances and odor-masking agents in flowable solids, such as granular or pelleted solids, including those used as absorbents or adsorbents, such as dehumidifiers/desiccants, small animal bedding, and litter materials, including cat litter. The porous crystalline materials can be incorporated into the material used to form the granules or pellets (such as cellulosic materials, including papers or woody materials (e.g., pine), clays (e.g., bentonite), minerals, plant-based materials (e.g., wheat, corn, beet pulp), synthetic crystallized silica, activated carbon, and the like) and/or simply physically intermixed with such granules or pellets. The porous crystalline materials are thermally stable and biodegradable.

In addition to the use of hydrogen bonds, it is also possible to employ directional and reversible non-covalent sigma-hole (σ-hole) interactions such as halogen, chalcogen, and pnictogen bonds, for the assembly of the supramolecular porous host network. Such host networks can display similar advantageous features as those described above for HOFs, but they can offer more opportunities for bottom-up design and tailor-made properties driven by specific application/device/delivery/storage requirements.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 provides an illustration of the molecular structure of trimesic acid (left), the assembly of trimesic acid into hexagons (middle), the resulting porous crystalline solid framework (right).

FIG. 2 shows the structure of an exemplary iodonium bridged N···I⁺···N based halogen-bonded organic framework.

FIG. 3A is a cartoon illustration of heterogeneous synthesis.

FIG. 3B is a cartoon illustration of homogeneous synthesis.

FIG. 4 is a graph of a TGA trace of the material prepared through a homogenous route (with methanol as a solvent for the host), comprising trimesic acid and alpha-terpineol.

FIG. 5 is a computer rendered illustration of part of the crystal structure of trimesic acid:alpha-terpineol showing a channel containing guest molecules.

### DETAILED DESCRIPTION

Described herein are thermally stable, crystalline porous solids comprising a 3-dimensional matrix comprising, consisting essentially, or consisting of interconnected pores and open channels. The material (i.e., HOFs) can be “loaded” with various compounds that reside as “guests” in the open pores and channels of the “host” matrix material for molecular storage and controlled release of these volatile guest compounds. The supramolecular organic framework is characterized by weak, noncovalent, and reversible interactions (both physical and chemical) that allow for release of the guest compounds according to a desired manner. The rate and duration of release can be controlled and/or adjusted by adjusting the pore size and structure of the framework. This can be accomplished, for example, by adjusting the size of the framework building blocks (e.g., larger or smaller molecules, longer or shorter ‘arms’, etc. to achieve larger or smaller pores and/or channels within the matrix). The desired properties of the framework can be paired with the corresponding properties (e.g., molecular size, vaporization rate), desired release rate of the volatile guest, and conditions of the release environment (e.g., temperature, humidity, pressure), if applicable. In one or more embodiments examples, the host matrix has pore sizes ranging from 1 nm to about 10 nm. As used herein, reference to a pore “size” refers to the maximum surface-to-surface dimension of the pore opening (e.g., in the case of substantially circular pores, this would be the diameter of the pore).

The crystalline size of the materials can also be adjusted, such as by controlling the rate of nucleation during synthesis, the rate of saturation or super saturation with the guest, as well as the temperature and other synthesis conditions (such as choice of solvent). The materials preferably have a crystalline size, as measured by powder X-ray diffraction or microscopy, of less than about 500 microns, preferably less than about 250 microns, more preferably less than about 100 microns (+/−5 microns).

The materials can be used to deliver volatile substances, including volatile active agents that act as pesticides, insecticides, fungicides, fragrances, flavoring agents, odorants, aromas, flavorings, pheromones, odor-maskants, deodorants, disinfectants, inks, drugs, germicides, dyes, and the like.

Thus, the materials can be initially in the form of a crystalline powder, preferably a fine powder (e.g., having a crystalline size of less than 250 microns), which can be applied as a dusting via a nozzle sprayer. The materials can also be in the form of larger granules or particulates that can be dispersed, spread, or applied to the desired surfaces or in the desired areas. Crystalline powder formulations can also be subsequently formed/compacted into solid tablets or encapsulated in capsules, or otherwise integrated into a variety of delivery carriers, vehicles, or formats. The delivery carrier or vehicle can be an active substance (i.e., one that itself has a function, utility, or purpose, even if aesthetic, such as to absorb moisture, treat the applied area, cover the area, etc.) or it can be an “inert” material (i.e., one that has the primary function of facilitating storage and/or delivery of the HOFs). A carrier or delivery vehicle can be considered inert, even if it has some incidental function (e.g., water that provides moisture to soil), so long as its primary function in the composition is for delivery of the HOFs.

For example, the HOFs can be prepared as composites wherein they are mixed with resins, and the like. The HOFs, such as in a crystalline powder, can also be dispersed into a liquid delivery vehicle for application or delivery, including aqueous or non-aqueous solvent systems. The HOFs can also be dispersed into any variety of coatings, thin films, layers, and the like, including paint (e.g., for walls, floors, ceilings, furniture, furnishings), nail varnish, clear coats, urethanes, stains, adhesives, and the like. The HOFs can also be incorporated into fabrics and textiles, such as carpets, rugs, clothing, furniture coverings, and the like, whether as part of the individual fibers or threads that make up the textile or fabric, or as a subsequently applied dip, soak, thin coat, layer, or the like. The HOFs can also be incorporated into or distributed within a granule or pellet composition.

Depending upon the compound (building blocks) used to form the matrix, the porous framework can be biodegradable (e.g., enzymatically degradable), moisture degradable, pH degradable, and the like. The building blocks exemplified herein typically yield matrices that are poorly soluble in water. However, the water solubility of the HOF matrix can be designed to be more or less soluble in water depending upon the selected building blocks and their underlying water solubility.

### The Host Framework

The successful construction of stable porous frameworks first involves selection of suitable molecular building blocks (‘tectons’). Molecular features such as size, rigidity, planarity, symmetry, functionality, and geometry are important parameters that influence the dimensionality and the robustness of the framework. While stability is a critical requirement of the porous organic framework, the extent and nature of permanent porosity is also of great importance. Consequently, the primary challenge is to construct a framework that satisfies both criteria. The use of different building blocks enables the construction of frameworks with different pore sizes and shapes. Trimesic acid is an exemplary compound. Other suitable building blocks for porous hydrogen-bonded organic frameworks, HOFs, are shown below. It is important that the building blocks are polyfunctional, preferably at least trifunctional (i.e., having at least three moieties that can form reliable and directional intermolecular interactions).

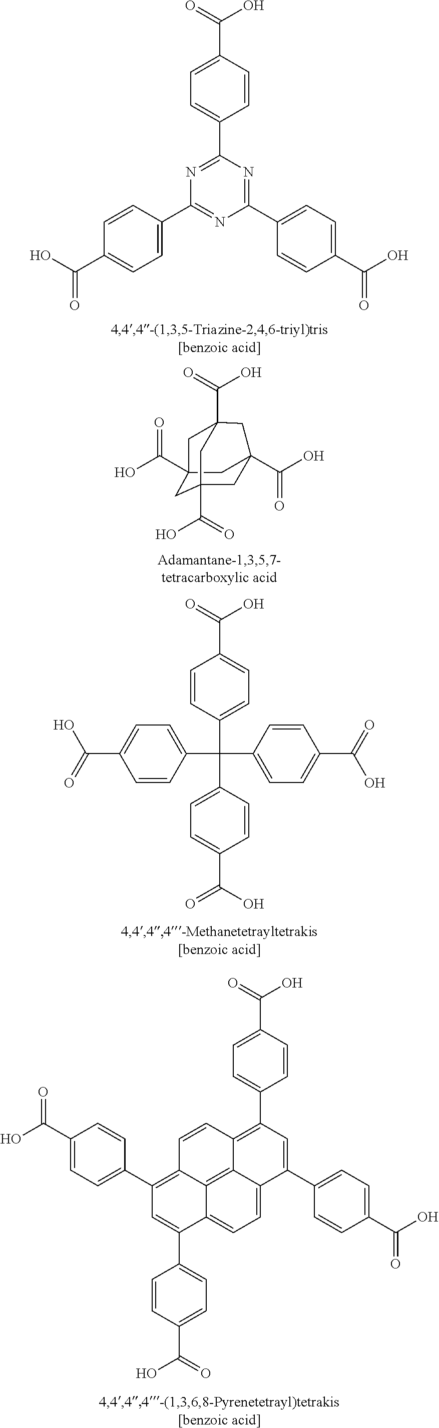 [SMILES: O=C(O)c1ccc(-c2nc(-c3ccc(C(=O)O)cc3)nc(-c3ccc(C(=O)O)cc3)n2)cc1 ; O=C(O)C12CC3(C(=O)O)CC(C(=O)O)(C1)CC(C(=O)O)(C2)C3 ; O=C(O)c1ccc(C(c2ccc(C(=O)O)cc2)(c2ccc(C(=O)O)cc2)c2ccc(C(=O)O)cc2)cc1 ; O=C(O)c1ccc(-c2cc(-c3ccc(C(=O)O)cc3)c3ccc4c(-c5ccc(C(=O)O)cc5)cc(-c5ccc(C(=O)O)cc5)c5ccc2c3c54)cc1]

Self-complementary compounds, such as amides, oximes, alcohols, amino-pyridines, and triazines can also be used, instead of carboxylic acids. Depending on the periodic group of the donor atom, non-covalent interactions such as halogen/chalcogen/pnictogen bonded porous frameworks can be employed, in addition to HOFs. As an example, a triptycene tris(1,2,5-selenadiazole) building block, below, can be used to assemble a porous chalcogen-bonded organic framework.

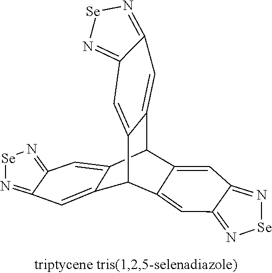 [SMILES: c1c2c(cc3n[se]nc13)C1c3cc4n[se]nc4cc3C2c2cc3n[se]nc3cc21]

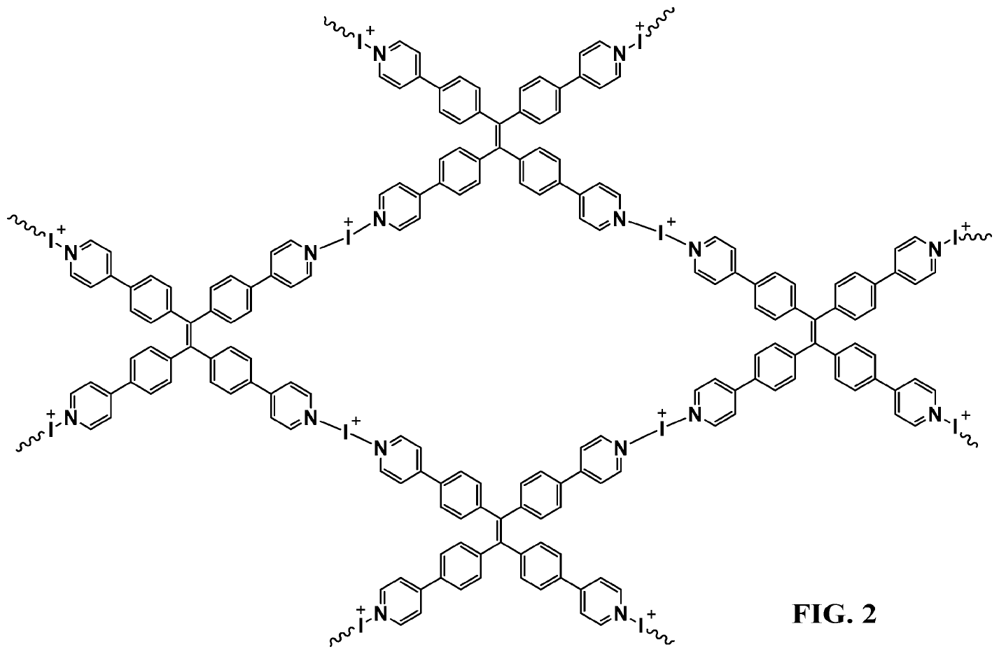

In addition, the framework architecture can be constructed using halogen-bonds. For example, a 1,1,2,2-tetrakis(4-(pyridin-4-yl)phenyl)ethane (TPPE) backbone can be used to build an iodonium bridged N···I⁺···N based halogen-bonded organic framework (see FIG. 2). Furthermore, framework architecture can be constructed using multi-component (heteromeric) organic assemblies, often referred to as co-crystals. Examples of such a framework would be the combination of a building block with four halogen-bond acceptor sites at the corners of a near tetrahedral or planar molecule (see below).

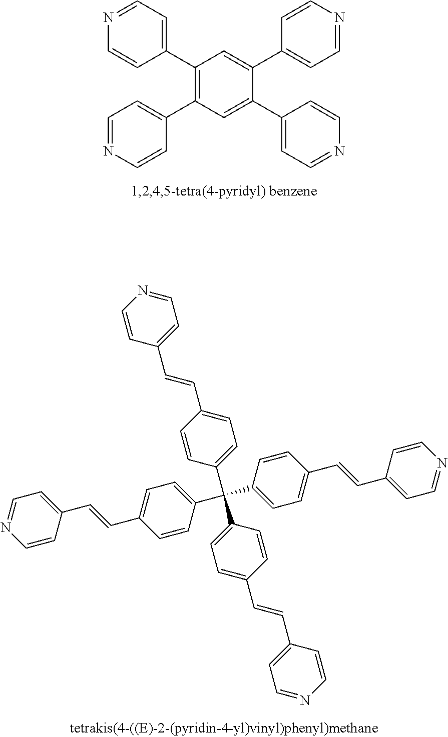

These tetra-dentate halogen-bond acceptors are then combined with suitable halogen-bond donors, such as trifluorotriiodobenzenes and tetrafluorodiiodobenzenes (below), in order to create the desired supramolecular porous framework.

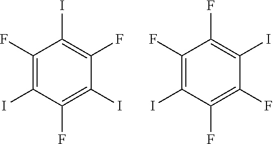

### The Volatile Guest

A wide range of volatile guest molecules are suitable targets for the capture and slow release by porous organic frameworks, and different molecular features of the guest allows for specific structure-property correlations to be established. For example, ethyl butyrate was selected as an exemplary molecule because of its small size and to explore how hydrophilicity impacts its encapsulation as a guest molecule. On the other hand, ethyl vanillin was selected as an exemplary molecule because it is a food fragrance used for artificial flavor. Also, coumarin was employed as an exemplary molecule in order to determine the capability of the HOFs to take up relatively large molecules and also because it is a commercially important dye/fragrance.

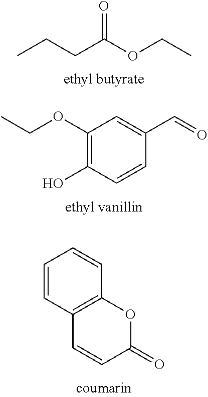

Insects and plants are known to produce a variety of volatile metabolites. More importantly, plant volatiles play a major role in plant biology, such as in attracting pollinators like beetles and bees, but can also be used by plants to defend from herbivores. Similarly, insects use pheromones for mating, and such volatile metabolites can be used to evaluate the likelihood of supramolecular porous hosts to uptake such volatile guests for controlled release. To extend the guest library, a range of molecular structures of plant and insect volatiles below were selected based on size and functionality such as aliphatics, aromatics, heterocyclics, and terpenoids.

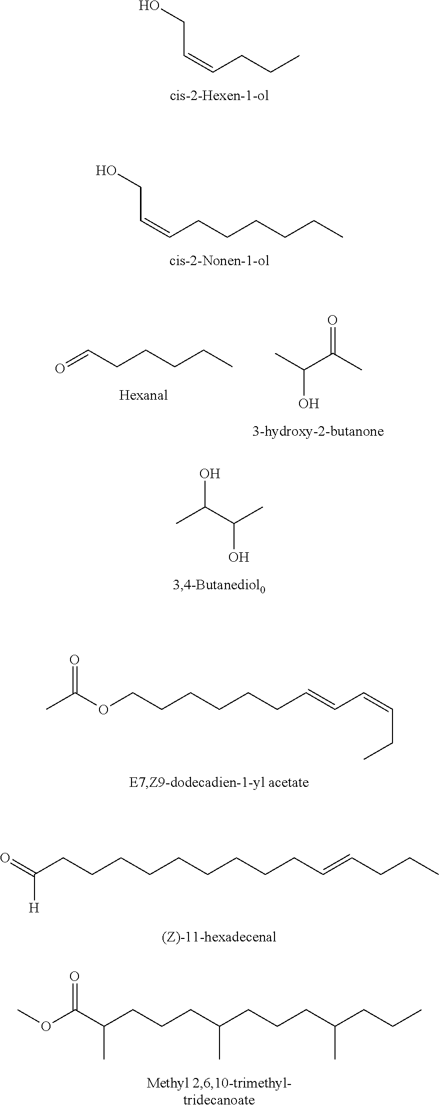

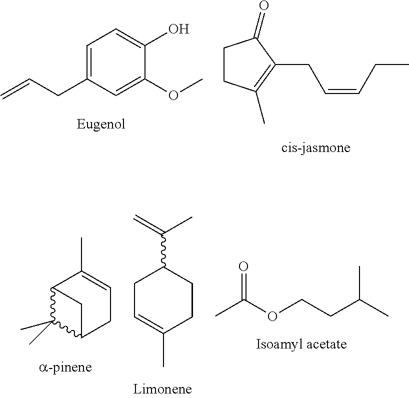

Furthermore, other volatile organic compounds below were selected because of their applications in products such as paints, adhesives, agrochemical formulations, and furnishing coatings.

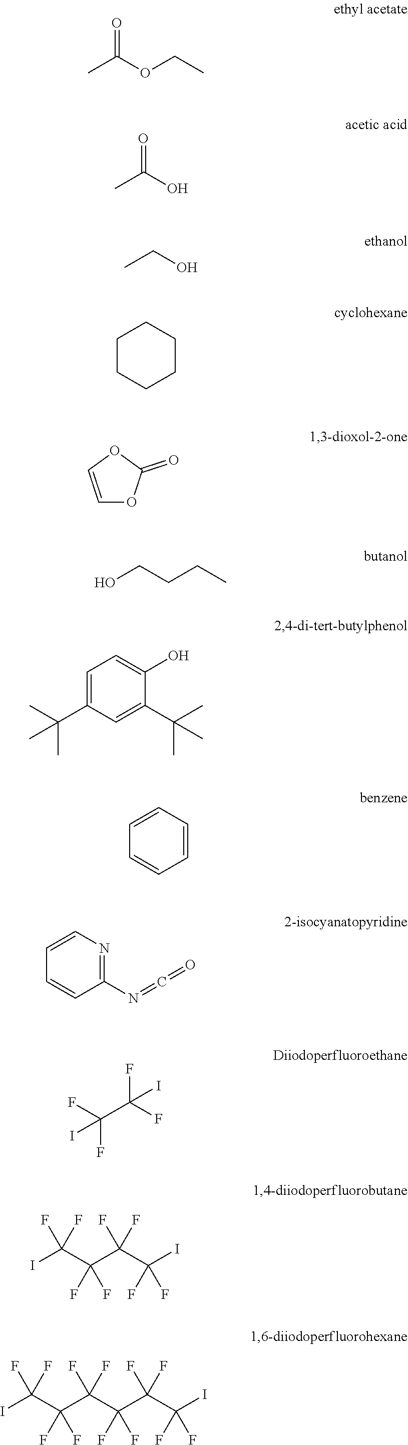

In principle, the supramolecular framework can host one or more volatile guests, even different volatile guests. In general, common properties of guests suitable for loading into the porous hosts include those having a relatively low boiling point (e.g., less than 100° C.), high vapor pressure (e.g., above 25 mmHg at room temperature), low molecular weights (e.g., below 900 amu), and limited solubility in water (e.g., below 100 mg/L).

### Synthesis

The loaded frameworks can be prepared by soaking (heterogenous method) or evaporation (homogenous method).

In one aspect, the volatile molecules are incorporated into a hydrogen-bonded porous framework using a co-crystallization method. The framework building blocks and volatile guest compounds are dispersed into a mixture in a suitable solvent system and stirred to maintain homogenous mixing of the compounds. After a suitable time period (e.g., from about one to about ten minutes), the mixture is allowed to rest, preferably under ambient conditions for gradual evaporation of the solvent system, until crystals are obtained. For highly viscous liquids, at ambient conditions, an additional organic solvent, such as ethyl acetate, acetone, methanol, etc., may be required to dissolve the framework building block.

In a second approach, a pre-formed supramolecular matrix, such as a dry crystalline powder can be dispersed in a suitable quantity of guest compound, preferably under ambient conditions, followed by vigorous mixing for a suitable period of time (e.g., from about one minute to an hour). Excess guest compound that is not encapsulated into/onto the matrix pores and channels of the host can then be removed by filtering the crystals and washing with hexane or another suitable solvent.

### Applications

The use of a supramolecular porous organic framework offers a modular, lightweight, thermally stable, and biodegradable alternative to existing porous solids. The chemistry of the host can be modified in such a way that pore size and guest release rate can, in principle, be modified and tailored to a specific application. The present invention presents an eco-friendly and gradual/controlled delivery platform for pesticides, herbicides, fungicides, personal-care products and cosmetic odorants or deodorants, germicides, antibacterial agents, and the like. The loaded porous hosts can also be incorporated into devices for long-term and sustainable delivery and distribution of fragrances and odor-masking agents, as well as for the storage and delivery of volatile semiochemicals. By way of example, the supramolecular porous organic framework can be designed such that the volatile guest is (or will be) released at a slower rate as compared to the rate of volatilization of the pure compound, such as to enable gradual release of the guest over a period of several minutes, hours, days, weeks, and the like. The release rate can be altered by changing the host, and/or by changing the type of interactions that bind the guest to the porous framework. The improvement in retention time of the guest can range from a few hours to several weeks. In some embodiments, the guest is gradually released over a period of at least 30 minutes, at least 2 hours, at least 12 hours, at least 24 hours, at least 1 day, at least 2 days, at least 3 days, at least 4 days, at least 5 days, at least 6 days, at least one week, at least two weeks, at least 3 weeks, or at least 4 weeks, and in some cases for a month or longer.

In one or more embodiments, the volatile guest is (or will be) released at a slower rate as compared to the rate of volatilization of the pure compound (i.e., a control, without the framework), preferably wherein the rate of release is 10% slower than the pure compound, preferably 15% slower, preferably 20% slower, preferably 25% slower, preferably 30% slower, preferably 35% slower, preferably 40% slower, preferably 45% slower, preferably 50% slower, preferably 55% slower, preferably 60% slower, preferably 65% slower, preferably 70% slower, preferably 75% slower, preferably 80% slower, preferably 85% slower, preferably 90% slower preferably 95% slower than the pure compound. This can be calculated by

$$\frac{( release reate of guest - release rate of pure comopund )}{release rate of guest} = \%$$

In one or more embodiments, the volatile guest release duration will be at least twice that of the release duration of the pure compound (i.e., a control, without the framework), preferably at least 3, 4, 5, 6, 7, 8, 9, 10, 15, 20, 25, 30, 40, 50, 60, 70, 80, 90, 100, 200, 300, 400, 500, 600, 700, 800, 900, or 1,000 times that of the duration of the pure compound. For example, where a pure compound is normally released in minutes, the loaded host will release the same volatile guest over a period of hours, days, weeks, or even months.

Additional advantages of the various embodiments of the invention will be apparent to those skilled in the art upon review of the disclosure herein and the working examples below. It will be appreciated that the various embodiments described herein are not necessarily mutually exclusive unless otherwise indicated herein. For example, a feature described or depicted in one embodiment may also be included in other embodiments but is not necessarily included. Thus, the present invention encompasses a variety of combinations and/or integrations of the specific embodiments described herein.

As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

The present description also uses numerical ranges to quantify certain parameters relating to various embodiments of the invention. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than about 10” (with no upper bounds) and a claim reciting “less than about 100” (with no lower bounds).

### EXAMPLES

The following examples set forth methods in accordance with the invention. It is to be understood, however, that these examples are provided by way of illustration, and nothing therein should be taken as a limitation upon the overall scope of the invention.

### Example 1

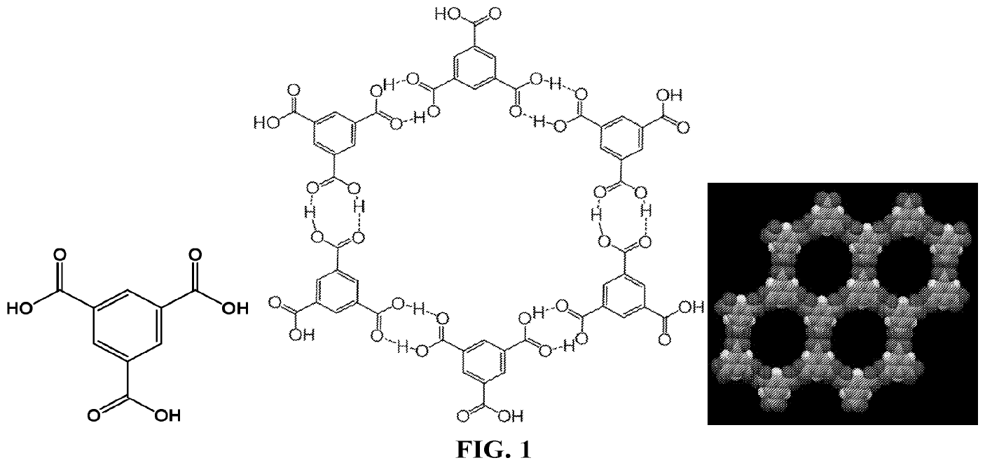

A wide range of building blocks capable of producing porous solid structures can be envisioned, and they can be assembled into the target structure using a variety of directional intermolecular forces such as e.g., hydrogen bonds, halogen bonds, and chalcogen bonds. Initially, we have focused our attention on trimesic acid, an inexpensive, thermally stable, and biodegradable compound capable of forming porous crystalline materials, FIG. 1.

In one approach, the HOF encapsulated guest was prepared by dissolving trimesic acid and guest in methanol a 1:8 molar ratio. The mixture was stirred at room temperature for up to 48 hours. The solution was then left undisturbed allowing for slow evaporation to take place until crystals were obtained. For particularly oily guest molecules, an additional solvent was required to dissolve trimesic acid. Successful guest uptake was confirmed by single crystal X-ray diffraction (SCXRD). Thermogravimetric analysis was used to monitor the weight loss as a function of temperature, and ¹H NMR was used to confirm the presence of both host and guest in the sample.

A second approach for incorporating the guest into the host framework relies on a “soaking” method. A stoichiometric amount of the dry powder/crystals of the HOF is dispersed in suitable volume of the liquid guest. The mixture is then vigorously stirred using an oscillator mechanical stirring. Finally, the crystals are filtered off, washed thoroughly with hexane or other suitable solvents to remove any guest from the surface of the crystals. The host-guest complex is then characterized as described in method (i).

In our initial studies we have examined the ability of the host, trimesic acid, to capture and retain a variety of volatile guest molecules of different molecular geometries and decorated with different chemical functional groups having the below structures.

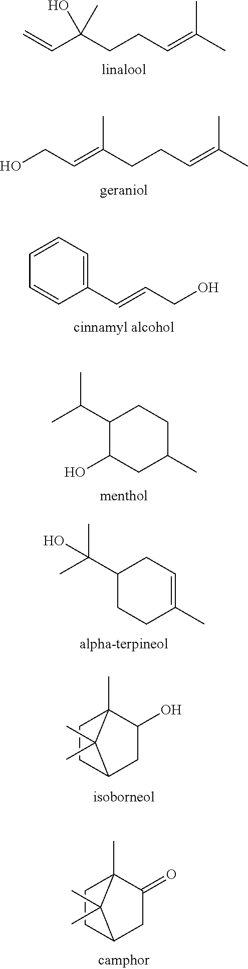

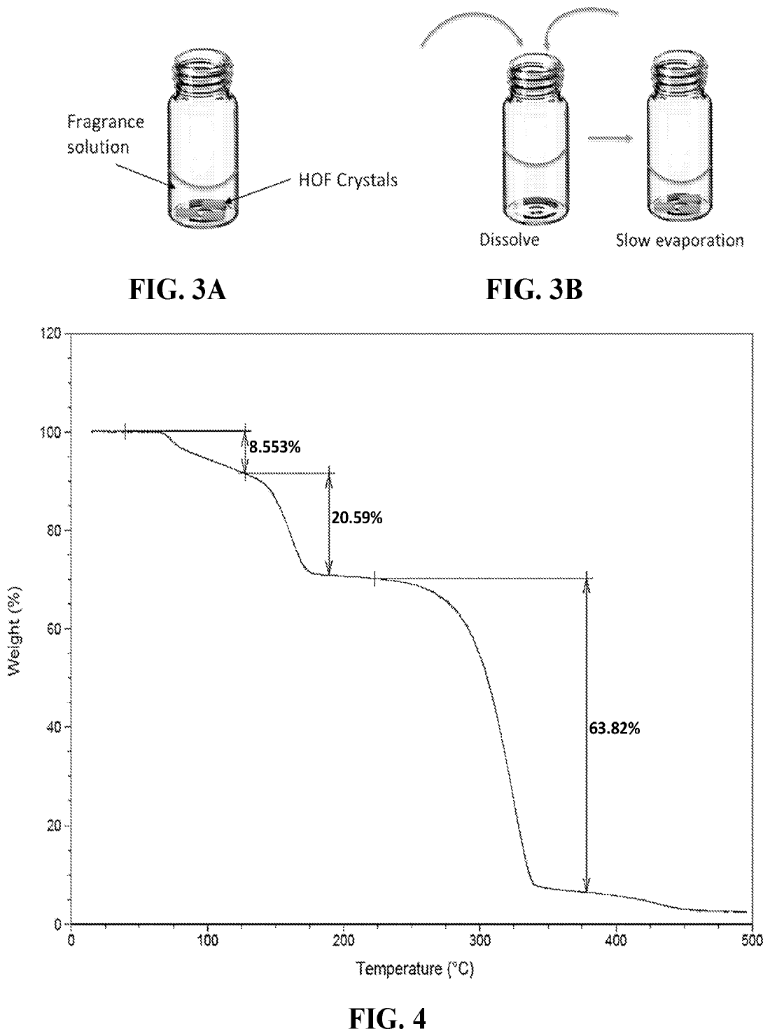

In a typical experiment, the volatile guest molecules are incorporated into the hydrogen bonded framework using the soaking method. A certain amount of the dry powder/crystals of the host is dispersed in a given volume of neat guest liquid, FIG. 3A. Alternatively, the host is first dissolved in a suitable solvent and then combined with a neat liquid (the guest), FIG. 3B.

In order to determine to what extent a particular guest is included within the host structure, we carried out thermal gravimetric analysis (TGA) on the resulting samples. A typical TGA measurement will record the weight-loss as a function of temperature and this will allow us to estimate the relative amount of solvent/guest/host present in a particular sample. The TGA trace for the host-guest material prepared from trimesic acid and alpha-terpineol is shown in FIG. 4. The TGA data for this host-guest compound reveals that it contains about 8.5% of solvent (likely a combination of water and methanol), and which is released at about 80-100° C. The volatile guest remains within the host up to about 150° C. and makes up 20.6% by weight of the sample. The host itself begins to thermally degrade at around 250° C.

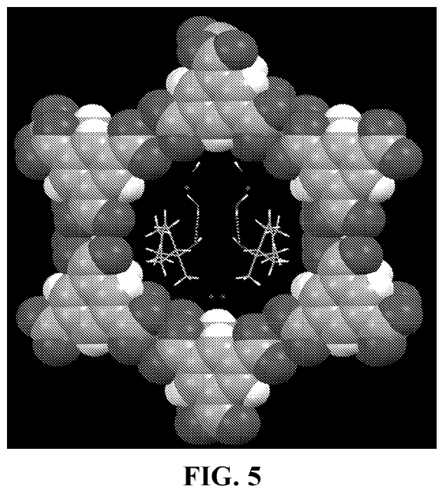

We were also able to grow crystals suitable for single-crystal X-ray diffraction analysis, which allowed us to determine the crystal structure of the host-guest complex. The sample remained stable for the duration of the experiment (>24 hours), and no notable escape of guest was detected, see FIG. 5

The X-ray analysis demonstrates that the intended (and necessary) porous crystal structure of the trimesic host has formed: the solid contains interconnected hexagonal channels and pores which allow for guest uptake. The structure also gives information about the chemical composition and relative arrangement of host, guest, and solvent molecules with respect to each other. In FIG. 5, we can see the hexagonal host channel structure (displayed in space-filling mode), with two alpha-terpineol guests and some disordered solvent molecules (water and methanol).

Our preliminary data have demonstrated that we can prepare a crystalline, porous, organic host-structure capable of incorporating a variety of volatile guests. We have also been able to determine loading-degrees, and crystal structures of some of the host-guest complexes.

1. A porous framework in the form of a crystalline powder for gradual release of an active guest compound, comprising an effective amount of a 3-dimensional host matrix of interconnected pores and open channels configured to house a guest compound, wherein said host matrix comprises a hydrogen-bonded organic framework defining said pores and channels, and at least one guest compound being a volatile compound, wherein said guest compound is housed substantially within said pores and channels of said host matrix.

2. The porous framework of claim 1, wherein said guest compound is selected from the group consisting of fragrances, odorants, aromas, flavorings, pheromones, pesticides, and odor-masking agents.

3. The porous framework of claim 1, wherein said guest compound is selected from the group consisting of esters, terpenes, aromatics, amines, alcohols, alkyl halides, and carboxylic acids.

4. The porous framework of claim 1, wherein said host matrix is biodegradable.

5. A method of delivering an active guest compound over time, said method comprising providing a porous framework according to claim 1, wherein said active guest compound is gradually released from said framework for a duration that is greater than the duration of release for a control active compound.

6. The method of claim 5, wherein said porous framework is provided in a location such that release of said active guest compound attracts insects to the location.

7. The method of claim 5, wherein said porous framework is provided in a location such that release of said active guest compound repels insects from the location.

8. The method of claim 5, wherein said porous framework is dispersed in a liquid coating, wherein said providing step comprises applying a layer of said liquid coating to a surface.

9. The method of claim 8, wherein said active guest compound emits an odor that masks an odor from said liquid coating.

10. The method of claim 5, wherein said active guest compound emits an odor.

11. The method of claim 5, wherein said porous framework is provided in a location on or near a plant.

12. The method of claim 11, wherein said release of said active guest compound inhibits growth of said plant.

13. The method of claim 11, wherein said release of said active guest compound inhibits a pest or fungal pathogen in said plant.

14. The method of claim 11, wherein release of said active guest compound improves growth of said plant.

15. The method of claim 5, wherein said porous framework is provided in a device container or composite containing said porous framework.

16. A composition comprising a porous framework according to claim 1 and a carrier.

17. The composition of claim 16, wherein said carrier is selected from the group consisting of an active or inert: liquid composition, powder composition, granular composition, pellet composition, or resin.

18. The composition of claim 17, wherein said carrier is a liquid composition selected from the group consisting of water, paints, stains, thin coatings, varnishes, and adhesives.

19. The composition of claim 17, wherein said carrier is a powder composition, granular composition, pellet composition selected from the group consisting of desiccants, odor absorbants, animal bedding, and animal litter.

20. The composition of claim 17, wherein said carrier is a resin, wherein said porous framework is distributed throughout said resin to form a composite composition.

21. The composition of claim 16, wherein said carrier is a fabric or textile.
